(19) United States
(12) Patent Application Publication
(10) Pub. No.: US 2017/0350160 A1
(43) Pub. Date: Dec. 7, 2017

(54) HOCKEY PUCK DOOR KNOB

(71) Applicant: Brandon C. Block, Orchard Park, NY (US)

(72) Inventor: Brandon C. Block, Orchard Park, NY (US)

(21) Appl. No.: 15/685,699

(22) Filed: Aug. 24, 2017

Related U.S. Application Data
(63) Continuation-in-part of application No. 29/542,671, filed on Oct. 16, 2015, now Pat. No. D797542.

(51) Int. Cl. E05B 1/00; E05B 17/22

(52) U.S. Cl. CPC E05B 1/0084; E05B 17/226; E05B 1/0007; E05B 1/0015

(57) ABSTRACT

A door knob having a handle shaped as a hockey puck. An illumination device, carried in a face of the handle is selectively illuminated by a control circuit carried within the handle. The control circuit may include a motion sensor to detect a movement of the handle or a motion in front of the device and activate the illumination device. A timer may be connected with the control circuit to deactivate the illumination device after passage of a predetermined time. The door knob may also include a sound emitter coupled to the control circuit to make a sound when the illumination device is activated or in the case without illumination to activate when a movement of the handle is detected. The sounds may be selected to correspond to a sports event, holidays, phrases, sayings or slogans.

### CROSS-REFERENCE TO RELATED APPLICATION

This application is a continuation in part of U.S. Design patent application Ser. No. 29/542,671, filed Oct. 16, 2015 the contents of which are herein incorporated by reference.

### BACKGROUND OF THE INVENTION

The present invention relates to doorknobs and, more particularly, features an actual hockey puck as the door knob. These hockey puck door knobs display different images, logos & artwork on the face of the puck.

The puck knobs may feature professional & college sport team logos as well as local team logos and is not limited to Hockey (includes all sports concepts).

The puck knobs may additionally feature digital photos of individuals as well a teams photos, team numbers and names.

The puck knobs may also feature business logos and specialty images of meaningful expressions in a word or image as pertaining to an area, a town, a current event, holiday or happening. Puck knob can feature any image that is designed or printable.

As can be seen, there is a need for an improved aspect of the puck knob. The knob offers additional qualities of sound and light illumination. Sound acts a novelty to the component and light acts as both a safety feature as well as a novelty of the item.

### SUMMARY OF THE INVENTION

In one aspect of the present invention, a door knob includes a handle formed in the shape of an actual hockey puck; an attachment mechanism to secure the handle to a door; and an illumination device and a control circuit carried in the handle. The control circuit is operable to selectively activate the illumination device. The attachment mechanism may include a shaft having a first end extending from a back surface of the handle and a second end rotationally coupled to a latch mechanism for selectively securing the door in a closed position.

A movement & motion sensor may be coupled to the control circuit and carried within the handle, such that upon detection of a movement of the handle by the movement sensor or a motion in front of the device the control circuit activates the illumination device. A timer may also be coupled to the control circuit, wherein the illumination device is deactivated after passage of a predetermined time after activation of the illumination device.

The illumination device may include a plurality of light emitting diodes carried in a front face of the handle in a spaced apart relation around a periphery of the front face. Alternatively, it may include a shaped lens carried in a central region of the front face, wherein the illumination device illuminates through the shaped lens. The illumination device may also include an annular lens carried in a periphery of the front face, wherein the illumination device illuminates through the annular lens.

In some embodiments, an audio emitter is operatively coupled to the control circuit and the audio emitter configured to play a sound upon activation of the illumination device. Or singularly without illumination, a movement sensor may be coupled to the control circuit and carried within the handle, such that upon detection of a movement of the handle by the movement sensor the control circuit activates the audio emitter. A timer may also be coupled to the control circuit, wherein the audio emitter is deactivated after passage of a predetermined time after activation of the audio emitter.

The audio may include a plurality of sounds selected to correspond to a sports game. Additionally sound may include a plurality of sounds selected to correspond with but, not limited to, a particular phrase, event or holiday. The sound may be selected based on whether the motion sensor is activated by the knob turning. The audio may play the same phrase with each turn of the knob or have a series of several sounds that play in order then repeat once the last sound plays with each turn of the knob.

A battery compartment and battery may be carried within the handle and operatively coupled to the control circuit. A manually activated switch may also be included and is configured to selectively power the control circuit.

These and other features, aspects and advantages of the present invention will become better understood with reference to the following drawings, description and claims.

### BRIEF DESCRIPTION OF THE DRAWINGS

FIG. 1 is a perspective view of a first embodiment of a hockey puck door knob.

FIG. 2 is a perspective view of a second embodiment of the hockey puck door knob.

FIG. 3 is a perspective view of a third embodiment the hockey puck door knob.

FIG. 4 is a perspective view of a fourth embodiment the hockey puck door knob.

FIG. 5 is a perspective view of a fifth embodiment the hockey puck door knob.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved door knob that provides a source of illumination and/or an optional audio emission from a door knob handle. The door knob includes a handle 10 formed in the shape of a hockey puck. In other embodiments the handle 10 maydisplay logos, (digital, laser, screen printed or any printing format) images, logos and designs of other sports teams, events, happenings or other general designs. An attachment mechanism secures the handle 10 to a door 34, which may be a door providing access or entry to a room. The attachment mechanism may include a shaft 32 having a first end extending from a back surface 14 of the handle 10 and a second end rotationally coupled to a latch mechanism 34 for selectively securing the door 34 in a closed position.

An illumination device and a control circuit are carried in the handle 10. The control circuit is operable to selectively activate the illumination device. A movement/motion sensor 24 coupled to the control circuit and carried within the handle 10. The movement/motion sensor 24 is configured to detect a movement/motion of the handle to cause the control circuit to activate the illumination device. A timer may be coupled to the control circuit, wherein the illumination device is deactivated after passage of a predetermined time after an activation of the illumination device.

The handle 10 may also be configured with an audio emitter 26 and is operatively coupled to the control circuit. The audio emitter is configured to play a sound(s) upon activation of the illumination device or on it's own without illumination when the handle is turned and motion is detected. The sound may be selected from a plurality of sounds associated with a sports game, events holidays, phrases, sayings or slogans. The sound will display sports commentary & other sounds that will add to the fun factor of the knob's features. For example, when the handle is turned a sound “he shoots, he scores” and the crowd goes wild . . . ” The audio emitter 26 may also be configured to select one of the plurality of sounds depending upon the movements sensed by the motion sensor 24. For example, the sound of a “slap shot” may be played when the door is opened, and the sounds of a player checking another player into the boards may be played when the door is closed. The audio emitter 26 may also project from the back surface 14 and reflect the audio signal against the door 34 for projection into the room.

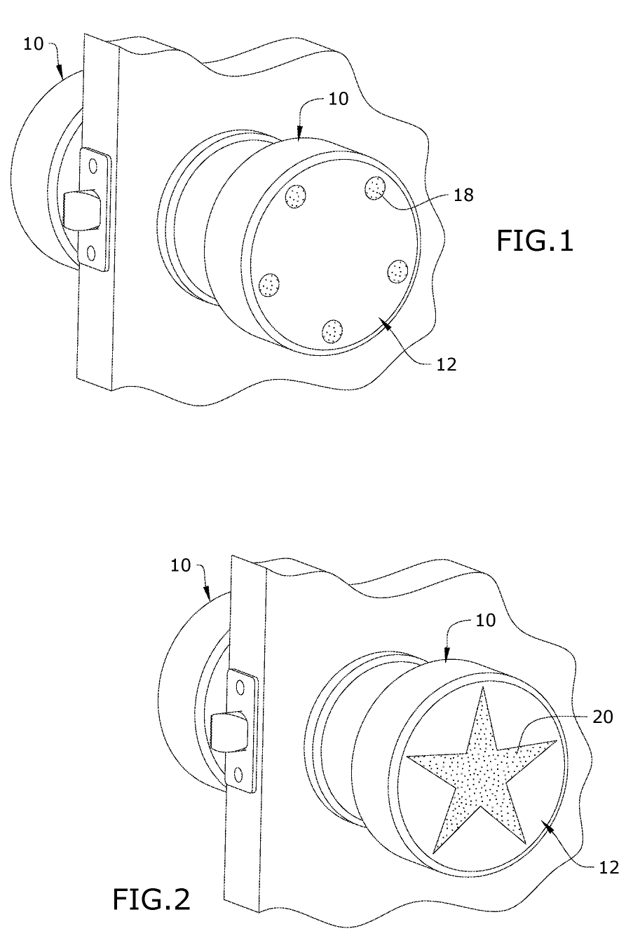

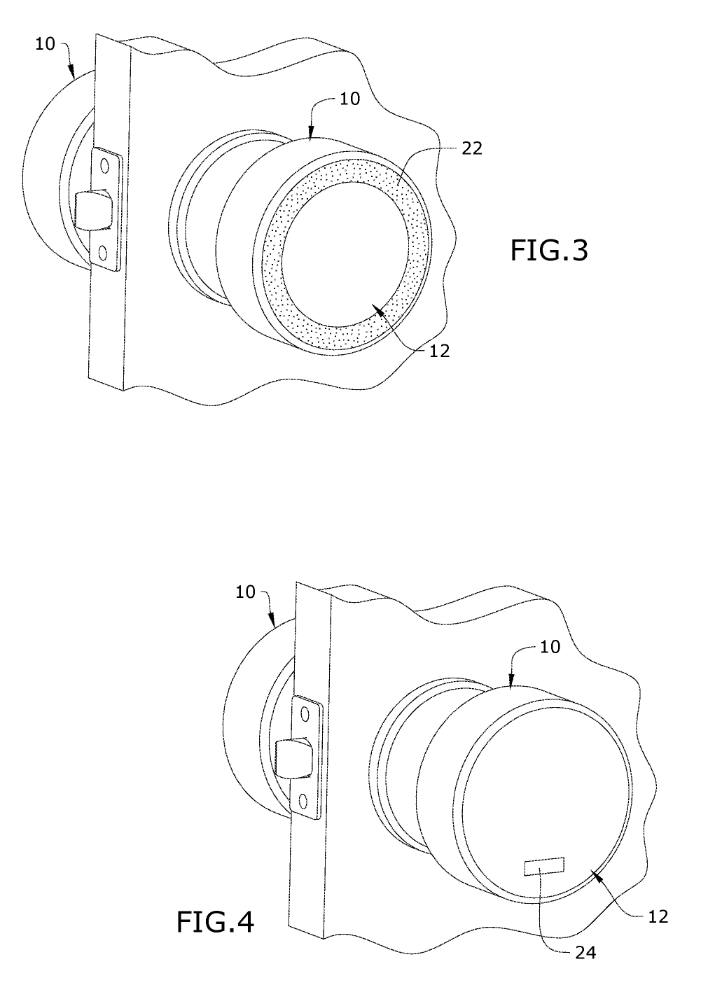

As seen in reference to FIG. 1, the illumination device may include plurality of light emitting diodes 18 carried in a front face 12 of the handle 10 in a spaced apart relation around a periphery of the front face. As seen in reference to FIG. 2, the illumination device may include a shaped lens 20 carried in a central region of the front face 12, wherein the illumination device illuminates through the shaped lens 20. The shaped lens 20 may be selected from any of a number of logos associated with a sports team or other images. As seen in reference to FIG. 3, the illumination device may include an annular lens 22 carried in a periphery of the front face 12, wherein the illumination device is configured to illuminate through the annular lens 22.

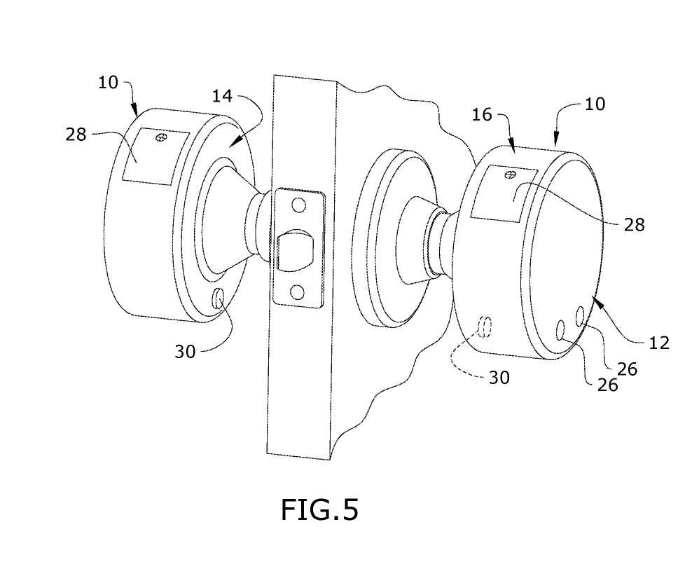

As seen in reference to FIG. 5, the door knob 10 may also include a battery compartment carried within the handle 10 and operatively coupled to the control circuit. The battery compartment may include an access panel 28 to install or replace a battery contained within the battery compartment. A manually activated switch 30 may be carried on the back surface 14 and is configured to selectively power the control circuit.

As indicated, the handle 10 is formed from an official standard hockey puck. It may include features, such as a decal or image that is machined in the front face 12 of the handle 10 and may be pressed on the door handle shaft and grips tightly. For the lighted version a machined recess (cut) of the image may be taken out of the puck and lens fitted in its place that would pass light through. The machine cut may also provide space to carry any lights, circuit board and other wires necessary to allow the subject to light for a reasonable amount of time before a new battery is needed. This would be accessible with a small Phillips screw. There may also be an on/off switch on the back of the Puck facing the door.

It should be understood, of course, that the foregoing relates to exemplary embodiments of the invention and that modifications may be made without departing from the spirit and scope of the invention as set forth in the following claims.

What is claimed is:

1. A door knob, comprising:
a handle formed in the shape of a game object;
an attachment mechanism to secure the handle to a door;
an illumination device and a control circuit carried in the handle, wherein the control circuit is operable to selectively activate the illumination device.

2. The door knob of claim 1, wherein the attachment mechanism comprises;
a shaft having a first end extending from a back surface of the handle and a second end rotationally coupled to a latch mechanism for selectively securing the door in a closed position.

3. The door knob of claim 1, further comprising:
a movement sensor coupled to the control circuit and carried within the handle, wherein detection of a movement of the handle by the movement sensor causes the control circuit to activate the illumination device.

4. The door knob of claim 3, further comprising:
a timer coupled to the control circuit, wherein the illumination device is deactivated after passage of a predetermined time after activation of the illumination device.

5. The door knob of claim 4, further comprising:
an audio emitter operatively coupled to the control circuit, the audio emitter configured to play a sound upon activation of the illumination device.

6. The door knob of claim 5, wherein detection of a movement of the handle by the movement sensor causes the control circuit to activate the audio emitter device.

7. The door knob of claim 5, wherein the illumination device comprises a plurality of light emitting diodes carried in a front face of the handle in a spaced apart relation around a periphery of the front face.

8. The door knob of claim 5, wherein the illumination device comprises a shaped lens carried in a central region of the front face, wherein the illumination device illuminates through the shaped lens.

9. The door knob of claim 5, wherein the illumination device comprises an annular lens carried in a periphery of the front face, wherein the illumination device illuminates through the annular lens.

10. The door knob of claim 5, wherein the sound comprises a plurality of sounds selected to correspond to a sports game.

11. The door knob of claim 5, wherein the sound comprises a plurality of sounds selected to correspond to an event.

12. The door knob of claim 10, wherein the one of the plurality of sound is selected based on whether the motion sensor detects a door opening or door closing.

13. The door knob of claim 5 further comprising:
a battery compartment carried within the handle and operatively coupled to the control circuit.

14. The door knob of claim 2, further comprising:
a battery contained within the battery compartment.

15. The door knob of claim 14, further comprising:
a manually activated switch configured to selectively power the control circuit.

16. A door knob, comprising:
a handle formed in the shape of a hockey puck;
an attachment mechanism to secure the handle to a door;
an audio emitter and a control circuit carried in the handle, wherein the control circuit is operable to selectively activate the audio emitter.

17. The door knob of claim 16, further comprising:
a movement sensor coupled to the control circuit and carried within the handle, wherein detection of a movement of the handle by the movement sensor causes the control circuit to activate the audio emitter.

18. The door knob of claim 17, further comprising:
an illumination device the handle, wherein the control circuit is operable to selectively activate the illumination device.
